(19) United States
(12) Patent Application Publication
(10) Pub. No.: US 2025/0287089 A1
(43) Pub. Date: Sep. 11, 2025

(54) ATTACHMENT FOR BORE INSPECTION SYSTEM

(71) Applicant: SPM Oil & Gas Inc., Fort Worth, TX (US)

(72) Inventor: Michael C. Zanoff, Westworth Village, TX (US)

(73) Assignee: SPM Oil & Gas Inc., Fort Worth, TX (US)

(21) Appl. No.: 18/595,897

(22) Filed: Mar. 5, 2024

(51) Int. Cl. H04N 23/50; F16L 55/40; F16L 101/30; H04N 23/55

(52) U.S. Cl. CPC H04N 23/555; F16L 55/40; H04N 23/55; F16L 2101/30

(57) ABSTRACT

An attachment for a bore inspection system for inspecting a bore of a component includes a first section adapted to be removably coupled to an imaging device of the bore inspection system. The first section extends along a central axis. The attachment also includes a fastener adapted to couple the first section with the imaging device and a second section integral with the first section and extending from the first section along the central axis. The second section includes a mirror that is disposed at an inclination angle of 45 degrees relative to the central axis. When the attachment is coupled to the imaging device, the mirror faces a lens of the imaging device so that light rays reflected from a bore wall of the bore, and to be received by the imaging device, are bent by an angle of 90 degrees by the mirror to inspect the bore wall.

### TECHNICAL FIELD

The present disclosure relates to a bore inspection system, and more particularly, to an attachment for the bore inspection system.

### BACKGROUND

Bores of components, such as engines or fracking equipment, may have to be periodically inspected in order to determine any damage or failure of one or more components of such components. The bores of the components are also inspected after manufacturing/assembly to ensure compliance with design requirements. Typically, an imaging device is used to determine a current condition of a bore wall of such bores. The imaging device are received within the bore of the component to capture images or videos of the bore wall of the bore. In some examples, it may be desired to take close-up images/videos of the bore wall. However, some bores are too narrow or small in diameter for the imaging device to be turned sideways to inspect the bore wall. Hence, a solution is desired to capture images or videos of the bore wall.

U.S. Pat. No. 8,587,647 describes a remote inspection device imager assembly that includes an imager body having a male threaded portion. An accessory assembly includes: a tubular body portion having first internal female threads engaged with the male threaded portion such that tubular body portion rotation axially translates the tubular body portion with respect to the imager body; and a mirror obliquely angled with respect to a longitudinal axis of both the imager assembly. A threaded coupler positioned between the imager body and tubular body portion has second internal female threads engaged with the male threaded portion. The threaded coupler is selectively axially translated by rotation to a first contact position with the imager body or a second contact position with the tubular body portion. The second contact position binds the first and second internal female threads with the male threaded portion to prevent tubular body portion axial rotation and fix a mirror orientation.

### SUMMARY OF THE DISCLOSURE

In an aspect of the present disclosure, an attachment for a bore inspection system for inspecting a bore of a component is provided. The attachment includes a first section adapted to be removably coupled to an imaging device of the bore inspection system. The first section extends along a central axis. The attachment also includes a fastener adapted to couple the first section with the imaging device. The attachment further includes a second section integral with the first section and extending from the first section along the central axis. The second section includes a mirror that is disposed at an inclination angle of 45 degrees relative to the central axis. Further, when the attachment is coupled to the imaging device, the mirror is adapted to face a lens of the imaging device so that light rays reflected from a bore wall of the bore, and to be received by the imaging device, are bent by an angle of 90 degrees by the mirror to inspect the bore wall.

In another aspect of the present disclosure, a bore inspection system for inspecting a bore of a component is provided. The bore inspection system includes an imaging device defining a first end and a second end. The imaging device includes a lens disposed proximal to the second end. The bore inspection system also includes an attachment. The attachment includes a first section adapted to be removably coupled to the imaging device of the bore inspection system. The first section extends along a central axis. The attachment also includes a fastener adapted to couple the first section with the imaging device. The attachment further includes a second section integral with the first section and extending from the first section along the central axis. The second section includes a mirror that is disposed at an inclination angle of 45 degrees relative to the central axis. Further, when the attachment is coupled to the imaging device, the mirror is adapted to face the lens of the imaging device so that light rays reflected from a bore wall of the bore, and to be received by the imaging device, are bent by an angle of 90 degrees by the mirror to inspect the bore wall.

In yet another aspect of the present disclosure, a method for inspecting a bore of a fracturing equipment is provided. The method includes providing an imaging device of a bore inspection system. The imaging device defines a first end and a second end. The imaging device includes a lens disposed proximal to the second end. The method also includes providing an attachment of the bore inspection system. The attachment includes a first section extending along a central axis, a fastener, and a second section integral with the first section and extending from the first section along the central axis. The second section includes a mirror that is disposed at an inclination angle of 45 degrees relative to the central axis. The method further includes coupling, via the fastener of the attachment, the first section of the attachment with the imaging device, such that the mirror of the second section faces the lens of the imaging device. The method includes inserting the bore inspection system within the bore of the fracturing equipment. The method also includes bending, by the mirror of the second section, light rays reflected from a bore wall of the bore, and receivable by the imaging device, by an angle of 90 degrees to inspect the bore wall.

Other features and aspects of this disclosure will be apparent from the following description and the accompanying drawings.

### BRIEF DESCRIPTION OF THE DRAWINGS

FIG. 1 illustrates an exemplary component and a bore inspection system for inspecting a bore of the component, according to an embodiment of the present disclosure;

FIG. 2 is a schematic perspective view of the bore inspection system of FIG. 1;

FIG. 3 is a schematic perspective view of an attachment of the bore inspection system of FIG. 2, according to an embodiment of the present disclosure;

FIG. 4 is a schematic cross-sectional side view illustrating the bore inspection system of FIG. 2 inserted within the bore of the component; and

FIG. 5 is a flowchart for a method of inspecting the bore of a fracturing equipment, according to an embodiment of the present disclosure.

### DETAILED DESCRIPTION

Wherever possible, the same reference numbers will be used throughout the drawings to refer to the same or like parts.

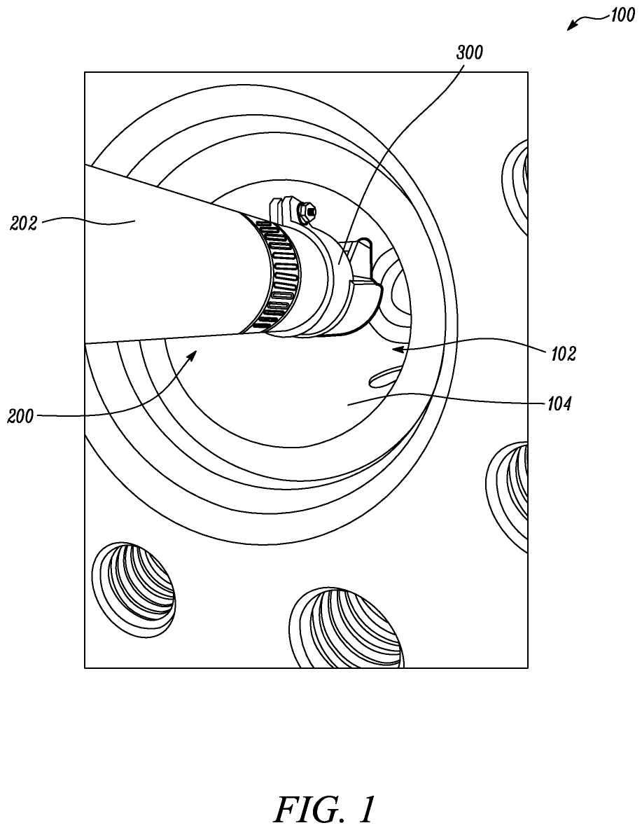

Referring to FIG. 1, an exemplary component 100 is illustrated. The component 100 includes, and may be interchangeably referred to as, a fracturing equipment 100 herein. Specifically, the fracturing equipment 100 includes a fluid end of a fracturing pump. Alternatively, the component 100 may include an internal combustion engine, a gas turbine engine, a pipe, a tube, or any other component that has bores, holes, openings, and the like. The component 100 includes a bore 102. The bore 102 defines a bore wall 104.

FIG. 1 also illustrates a bore inspection system 200 for inspecting the bore 102 of the component 100. It should be noted that the bore inspection system 200 may be used to inspect bores, holes, or openings of different shapes, such as, a circular shape, a square shape, a rectangular shape, an elliptical shape, a triangular shape, and the like. As illustrated in FIG. 1, the bore inspection system 200 is inserted into the bore 102 of the component 100 for inspection. The bore inspection system 200 may be used to inspect the bore wall 104 to detect damage or failures in the bore wall 104. Further, the bore inspection system 200 may be used to inspect the bore wall 104 to check compliance with desired design requirements. In some examples, the bore inspection system 200 may be used to inspect components or parts disposed in confined spaces or in machineries that may not be feasible to disassemble for minor inspection/repair purposes.

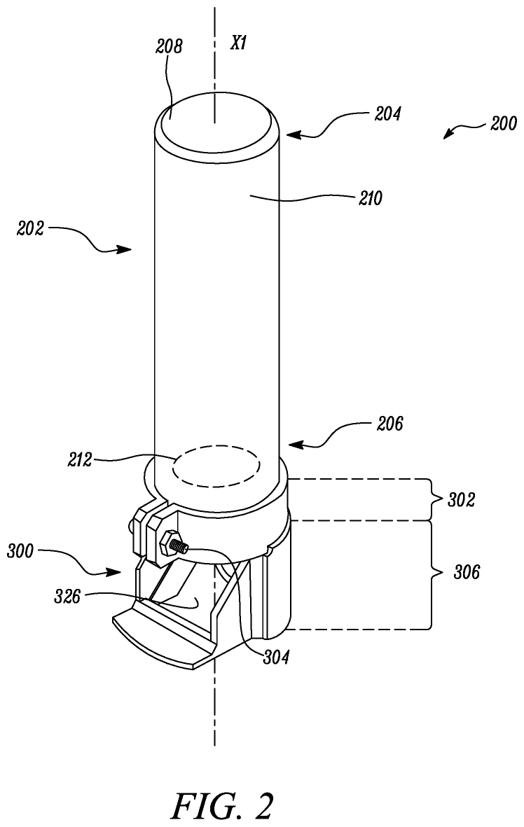

Referring to FIG. 2, the bore inspection system 200 includes an imaging device 202. The imaging device 202 may include a microscopic handheld camera, for example. It should be noted that the imaging device 202 may include any type of device that can capture images or videos. The imaging device 202 defines a first end 204 and a second end 206. The imaging device 202 includes a housing 208. The housing 208 is cylindrical in shape. The housing 208 has an outer profile 210 that is circular in shape. However, the outer profile 210 may be rectangular in shape, or square in shape, or elliptical in shape, as per application requirements. The imaging device 202 also includes a lens 212 disposed proximal to the second end 206. The lens 212 is disposed within the housing 208. The lens 212 may include an objective lens that gathers light rays from an object being observed and focuses the light rays to produce an image or video of the object.

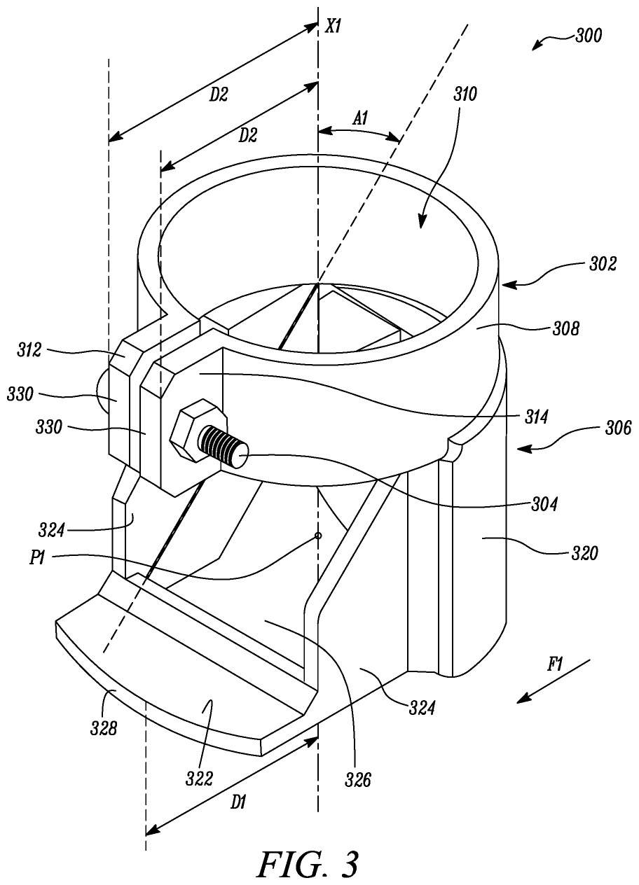

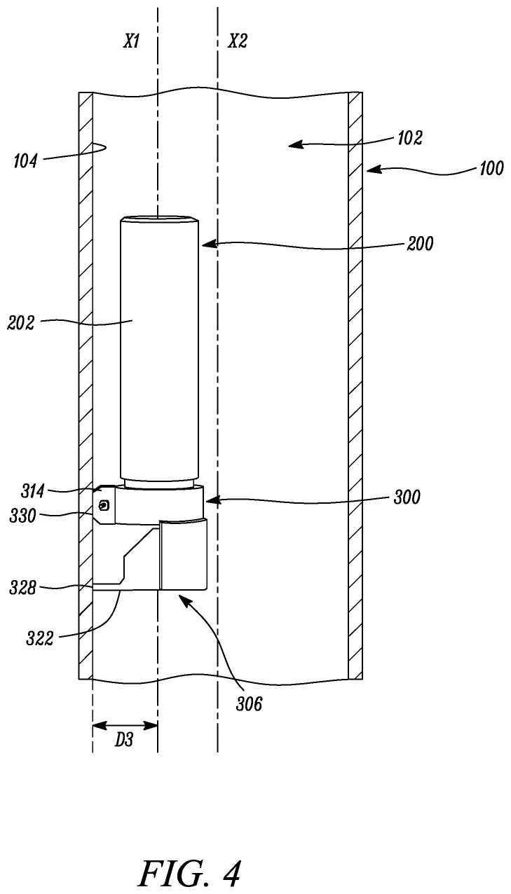

The present disclosure relates to an attachment 300 for the bore inspection system 200 for inspecting the bore 102 (see FIGS. 1 and 4) of the component 100 (see FIGS. 1 and 4). Referring to FIGS. 2 and 3, the bore inspection system 200 includes the attachment 300. The attachment 300 may be made from a metal, an alloy, or a polymer. The attachment 300 includes a first section 302 that is removably coupled to the imaging device 202 of the bore inspection system 200. The first section 302 extends along a central axis X1. The attachment 300 also includes a fastener 304 adapted to couple the first section 302 with the imaging device 202. The attachment 300 further includes a second section 306 integral with the first section 302 and extending from the first section 302 along the central axis X1.

Referring now to FIG. 3, the first section 302 includes a coupling portion 308. The coupling portion 308 defines a through-opening 310 to receive a portion of the imaging device 202 (see FIG. 2) therein. The through-opening 310 has a shape that corresponds to the outer profile 210 (see FIG. 2) of the portion of the imaging device 202. In the illustrated example of FIG. 3, the through-opening 310 has a circular shape. Specifically, the circular shape of the through-opening 310 allows the imaging device 202 to be partially received within the coupling portion 308. Alternatively, the through-opening 310 may have a rectangular shape, a square shape, an elliptical shape, based on the shape of the outer profile 210. It should be noted that a dimension of the coupling portion 308 may vary based on dimensions of the imaging device 202.

Further, the first section 302 includes a first projection 312 and a second projection 314. Each of the first projection 312 and the second projection 314 extends from the coupling portion 308 along a first direction F1 that is orthogonal to the central axis X1. The first projection 312 and the second projection 314 are similar in shape and dimensions. Each of the first and second projections 312, 314 are rectangular in shape. It should be noted that the first and second projections 312, 314 may have any other shape as per application requirements. The coupling portion 308 is integral with each of the first projection 312 and the second projection 314. Each of the first projection 312 and the second projection 314 is adapted to receive the fastener 304 to couple the first section 302 with the imaging device 202. Specifically, the first projection 312 defines a first through-hole (not shown) and the second projection 314 defines a second through-hole (not shown). The first through-hole aligns with the second through-hole to receive the fastener 304 to couple the first section 302 with the imaging device 202.

Further, the second section 306 includes an arcuate portion 320, a base surface 322 extending from the arcuate portion 320 along the first direction F1, and a pair of side plates 324 coupled to each of the arcuate portion 320 and the base surface 322. The base surface 322 and the pair of side plates 324 are integral with the arcuate portion 320. The side plates 324 extend orthogonally from the base surface 322 along the central axis X1.

Moreover, the second section 306 includes a mirror 326 that is disposed at an inclination angle A1 of 45 degrees relative to the central axis X1. The mirror 326 is retained within the second section 306 by each of the arcuate portion 320, the base surface 322, and the pair of side plates 324. In some examples, the mirror 326 may be retained within the second section 306 using suitable coupling means, such as, adhesives, fasteners, and the like. Further, when the attachment 300 is coupled to the imaging device 202, the mirror 326 faces the lens 212 of the imaging device 202 so that light rays reflected from the bore wall 104 (see FIG. 4) of the bore 102 (see FIG. 4), and to be received by the imaging device 202, are bent by an angle of 90 degrees by the mirror 326 to inspect the bore wall 104.

As shown in FIG. 3, an outer edge 328 of the base surface 322 is in-line with an outer edge 330 of each of the first projection 312 and the second projection 314. In other words, a distance D1 between the central axis X1 and the outer edge 328 of the base surface 322 is same as a distance D2 between the central axis X1 and the outer edge 330 of each of the first and second projections 312, 314. Further, the distance D1 between the central axis X1 and the outer edge 328 of the base surface 322, and the distance D2 between the central axis X1 and the outer edge 330 of each of the first and second projections 312, 314 is based on a desired stand-off distance D3 (shown in FIG. 4) defined between a central point P1 of the mirror 326 and the bore wall 104. It should be noted that the stand-off distance D3 is decided based on a desired focal length of the imaging device 202. Thus, a length of the base surface 322 and a length of each of the first and second projections 312, 314 may be varied to achieve the desired stand-off distance D3.

Referring now to FIG. 4, during an inspection of the bore wall 104, the bore inspection system 200 is inserted into the bore 102. Further, the central axis X1 along which the attachment 300 extends is parallel to an axis X2 of the bore 102. Furthermore, the outer edge 328 of the base surface 322 and the outer edge 330 of each of the first projection 312 and the second projection 314 engage with the bore wall 104 to dispose the mirror 326 (see FIG. 3) of the second section 306 at an angle of 45 degrees relative to the bore wall 104. In other words, the attachment 300 is pressed against the bore wall 104 to ensure that the imaging device 202 is focused and perpendicular to the bore wall 104. Specifically, when the attachment 300 is pressed against the bore wall 104, such that the imaging device 202 is disposed at the desired stand-off distance D3 from the bore wall 104, which may improve a focus of the imaging device 202.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure describes the attachment 300 for the bore inspection system 200. The attachment 300 can be removably coupled to any type of image capturing device to inspect bores, holes, or openings in various components, such as, engines, tubes, pipes, fracking equipment such as pumps, and the like. In an example, the bore inspection system 200 including the attachment 300 may be particularly usable in inspecting bores having a bore size between 2 inches and 8 inches, for example, because in such bores it may be difficult to turn the imaging device 202 sideways for inspecting the bores. Further, the attachment 300 may be easily and quickly coupled with the imaging device 202 without modifying a design of the imaging device 202. The attachment 300 may be easy to manufacture and provides a cost-effective solution to inspect the bore wall 104 of the bore 102.

The attachment 300 includes the first projection 312, the second projection 314, and the base surface 322 that may be pressed against the bore wall 104 to ensure the bore wall 104 is in focus. Further, the distance D1 between the central axis A1 and the base surface 322, and the distance D2 between the central axis A1 and each of the first and second projections 312, 314 is decided based on the desired stand-off distance D3. The distances D1, D2 may be varied by varying the dimensions of the base surface 322, the first projection 312, and the second projection 314 to achieve the desired stand-off distance D3. Further, when the imaging device 202 is disposed at the desired stand-off distance D3, the imaging device 202 may generate images of optimum quality, which may improve a usability and a reliability of the bore inspection system 200.

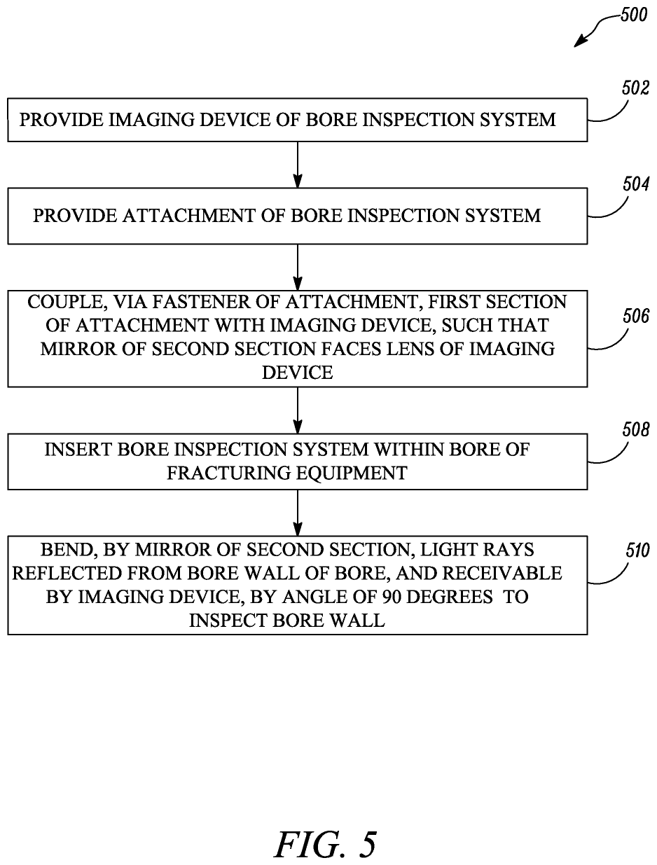

FIG. 5 is a flowchart for a method 500 for inspecting the bore 102 of the fracturing equipment 100. Referring to FIGS. 1 to 5, at step 502, the imaging device 202 of the bore inspection system 200 is provided. The imaging device 202 defines the first end 204 and the second end 206. The imaging device 202 includes the lens 212 disposed proximal to the second end 206.

At step 504, the attachment 300 of the bore inspection system 200 is provided. The attachment 300 includes the first section 302 extending along the central axis X1, the fastener 304, and the second section 306 integral with the first section 302 and extending from the first section 302 along the central axis X1. The second section 306 includes the mirror 326 that is disposed at the inclination angle A1 of 45 degrees relative to the central axis X1.

At step 506, the fastener 304 of the attachment 300 couples the first section 302 of the attachment 300 with the imaging device 202, such that the mirror 326 of the second section 306 faces the lens 212 of the imaging device 202.

At step 508, the bore inspection system 200 is inserted within the bore 102 of the fracturing equipment 100. At the step 508, the portion of each of the first section 302 and the second section 306 of the attachment 300 is engaged with the bore wall 104 of the bore 102 to dispose the mirror 326 of the second section 306 at the angle of 45 degrees relative to the bore wall 104 of the bore 102.

At step 510, the mirror 326 of the second section 306 bends light rays reflected from the bore wall 104 of the bore 102, and receivable by the imaging device 202, by the angle of 90 degrees to inspect the bore wall 104.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. An attachment for a bore inspection system for inspecting a bore of a component, the attachment comprising:
a first section adapted to be removably coupled to an imaging device of the bore inspection system, the first section extending along a central axis;
a fastener adapted to couple the first section with the imaging device; and
a second section integral with the first section and extending from the first section along the central axis, wherein,
the second section includes a mirror that is disposed at an inclination angle of 45 degrees relative to the central axis, and
when the attachment is coupled to the imaging device, the mirror is adapted to face a lens of the imaging device so that light rays reflected from a bore wall of the bore, and to be received by the imaging device, are bent by an angle of 90 degrees by the mirror to inspect the bore wall.

2. The attachment of claim 1, wherein the first section includes a coupling portion, wherein the coupling portion defines a through-opening adapted to receive a portion of the imaging device therein, and wherein the through-opening has a shape that corresponds to an outer profile of the portion of the imaging device.

3. The attachment of claim 2, wherein the through-opening has a circular shape.

4. The attachment of claim 2, wherein the first section includes a first projection and a second projection, wherein each of the first projection and the second projection extends from the coupling portion along a first direction that is orthogonal to the central axis, and wherein each of the first projection and the second projection is adapted to receive the fastener to couple the first section with the imaging device.

5. The attachment of claim 4, wherein the second section includes an arcuate portion, a base surface extending from the arcuate portion along the first direction, and a pair of side plates coupled to each of the arcuate portion and the base surface.

6. The attachment of claim 5, wherein an outer edge of the base surface is in-line with an outer edge of each of the first projection and the second projection, and wherein, during an inspection of the bore wall, the outer edge of the base surface and the outer edge of each of the first projection and the second projection is adapted to engage with the bore wall to dispose the mirror of the second section at an angle of 45 degrees relative to the bore wall.

7. The attachment of claim 6, wherein a distance between the central axis and the outer edge of the base surface, and a distance between the central axis and the outer edge of each of the first and second projections is based on a desired stand-off distance defined between a central point of the mirror and the bore wall.

8. The attachment of claim 1, wherein the component includes a fracturing equipment.

9. The attachment of claim 8, wherein the fracturing equipment includes a fluid end of a fracturing pump.

10. A bore inspection system for inspecting a bore of a component, the bore inspection system comprising:
an imaging device defining a first end and a second end, wherein the imaging device includes a lens disposed proximal to the second end; and
an attachment including:
a first section adapted to be removably coupled to the imaging device of the bore inspection system, the first section extending along a central axis;
a fastener adapted to couple the first section with the imaging device; and
a second section integral with the first section and extending from the first section along the central axis, wherein,
the second section includes a mirror that is disposed at an inclination angle of 45 degrees relative to the central axis, and
when the attachment is coupled to the imaging device, the mirror is adapted to face the lens of the imaging device so that light rays reflected from a bore wall of the bore, and to be received by the imaging device, are bent by an angle of 90 degrees by the mirror to inspect the bore wall.

11. The bore inspection system of claim 10, wherein the first section includes a coupling portion, wherein the coupling portion defines a through-opening adapted to receive a portion of the imaging device therein, and wherein the through-opening has a shape that corresponds to an outer profile of the portion of the imaging device.

12. The bore inspection system of claim 11, wherein the through-opening has a circular shape.

13. The bore inspection system of claim 11, wherein the first section includes a first projection and a second projection, wherein each of the first projection and the second projection extends from the coupling portion along a first direction that is orthogonal to the central axis, and wherein each of the first projection and the second projection is adapted to receive the fastener to couple the first section with the imaging device.

14. The bore inspection system of claim 13, wherein the second section includes an arcuate portion, a base surface extending from the arcuate portion along the first direction, and a pair of side plates coupled to each of the arcuate portion and the base surface.

15. The bore inspection system of claim 14, wherein an outer edge of the base surface is in-line with an outer edge of each of the first projection and the second projection, and wherein, during an inspection of the bore wall, the outer edge of the base surface and the outer edge of each of the first projection and the second projection is adapted to engage with the bore wall to dispose the mirror of the second section at an angle of 45 degrees relative to the bore wall.

16. The bore inspection system of claim 15, wherein a distance between the central axis and the outer edge of the base surface, and a distance between the central axis and the outer edge of each of the first and second projections is based on a desired stand-off distance defined between a central point of the mirror and the bore wall.

17. The bore inspection system of claim 10, wherein the component includes a fracturing equipment.

18. The bore inspection system of claim 17, wherein the fracturing equipment includes a fluid end of a fracturing pump.

19. A method for inspecting a bore of a fracturing equipment, the method comprising:
providing an imaging device of a bore inspection system, the imaging device defining a first end and a second end, wherein the imaging device includes a lens disposed proximal to the second end;
providing an attachment of the bore inspection system, wherein the attachment includes a first section extending along a central axis, a fastener, and a second section integral with the first section and extending from the first section along the central axis, and wherein the second section includes a mirror that is disposed at an inclination angle of 45 degrees relative to the central axis;
coupling, via the fastener of the attachment, the first section of the attachment with the imaging device, such that the mirror of the second section faces the lens of the imaging device;
inserting the bore inspection system within the bore of the fracturing equipment; and
bending, by the mirror of the second section, light rays reflected from a bore wall of the bore, and receivable by the imaging device, by an angle of 90 degrees to inspect the bore wall.

20. The method of claim 19, wherein the step of inserting the bore inspection system within the bore of the fracturing equipment further includes engaging a portion of each of the first section and the second section of the attachment with the bore wall to dispose the mirror of the second section at an angle of 45 degrees relative to the bore wall.
